(19) United States
(12) Patent Application Publication
(10) Pub. No.: US 2010/0248537 A1
(43) Pub. Date: Sep. 30, 2010

(54) CONNECTOR ASSEMBLY MOUNTED ONTO PANEL

(75) Inventors: YI ZHOU, Shenzhen (CN); XIAN-KUI SHI, Shenzhen (CN); CHUNG-YEN YANG, Tu-Cheng (TW); JIN-ZHI CHEN, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/732,414

(22) Filed: Mar. 26, 2010

(30) Foreign Application Priority Data
Mar. 26, 2009 (CN) 200920301636.4

(51) Int. Cl. H01R 13/73

(52) U.S. Cl. 439/571

(57) ABSTRACT

A connector assembly (100) adapted for mounting to a front panel (6) of a cage includes an insulative cover (4) having an upper cover and a lower cover extending along a front-to-back direction, at least one locating cavity (44) defined in a front segment of the lower cover, the locating cavity extending along a direction offsetting the front-to-back direction; a connector (2) accommodated in the locating cavity and held by the upper cover and the lower cover; and the connector (2) disposed perpendicular to the sloped front panel (6) and the cover (4) disposed oblique to the front panel.

### FIELD OF THE INVENTION

The present invention generally relates to a connector assembly, and more particularly to a connector assembly adapted to be mounted onto a panel.

### DESCRIPTION OF PRIOR ART

Commonly used input/output ports of a computer includes a USB connector, an Audio Jack, etc. Some of earlier produced computers are equipped with these ports which are mounted to a back panel of a cage thereof U.S. Pat. No. 5,637,015 issued to Tian et al. on Jun. 10, 1997 discloses an electrical connector assembly, and the electrical connector assembly includes two stacked USB connectors mounted to a back panel of a compute cage. However, such arrangement of the connectors is not friendly and convenient for a user, if a peripheral devices is to be connected/disconnected with the connectors.

Recently, efforts has been made to overcome aforementioned problem, for example, an improved connector assembly, which includes mostly used input/output ports being integrated together and is mounted to a front panel of a cage of a computer. U.S. Pat. No. 6,494,744 issued to Lee on Dec. 17, 2002 discloses a connector assembly mounted to a front panel, and the connector assembly has two connectors supported by a board located behind the front panel, and a front portion of the two connectors project outwardly via openings defined in the front panel and further supported by the front panel. The front panel is parallel to the board.

Nowadays, beautiful and unique ornamental design of an external cage of the computer becomes more and more important, and a front side of some computer is configured to be sloped structure instead of regular style. In addition, a board inside the external cage may disposed nonparallel to a front panel of the external cage. Therefore, the aforementioned connector is not suitable to be mounted to the front side which is sloped or the board inside the external cage.

Hence, an improved connector assembly is highly desired to overcome the aforementioned problems.

### SUMMARY OF THE INVENTION

Accordingly, an object of the present invention is to provide a connector assembly adapted to be mounted to a sloped front panel or a board nonparallel to a front panel of a computer.

In order to achieve the object set forth, a connector assembly adapted for mounting to a front panel of a cage in accordance with the present invention comprises an insulative cover having an upper cover and a lower cover extending along a front-to-back direction, at least one locating cavity defined in a front segment of the lower cover, the locating cavity extending along a direction offsetting the front-to-back direction; a connector accommodated in the locating cavity and held by the upper cover and the lower cover; and the connector disposed perpendicular to the sloped front panel and the insulative cover disposed oblique to the front panel.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of a connector assembly;

FIG. 2 is similar to FIG. 1, but viewed from another aspect;

FIG. 3 is an assembled view of the connector assembly;

FIG. 4 is similar to FIG. 3, but viewed from other direction; and

FIG. 5 shows the connector assembly mounted to a board and a sloped front panel.

### DETAILED DESCRIPTION OF PREFERRED EMBODIMENTS

Reference will now be made in detail to the preferred embodiment of the present invention.

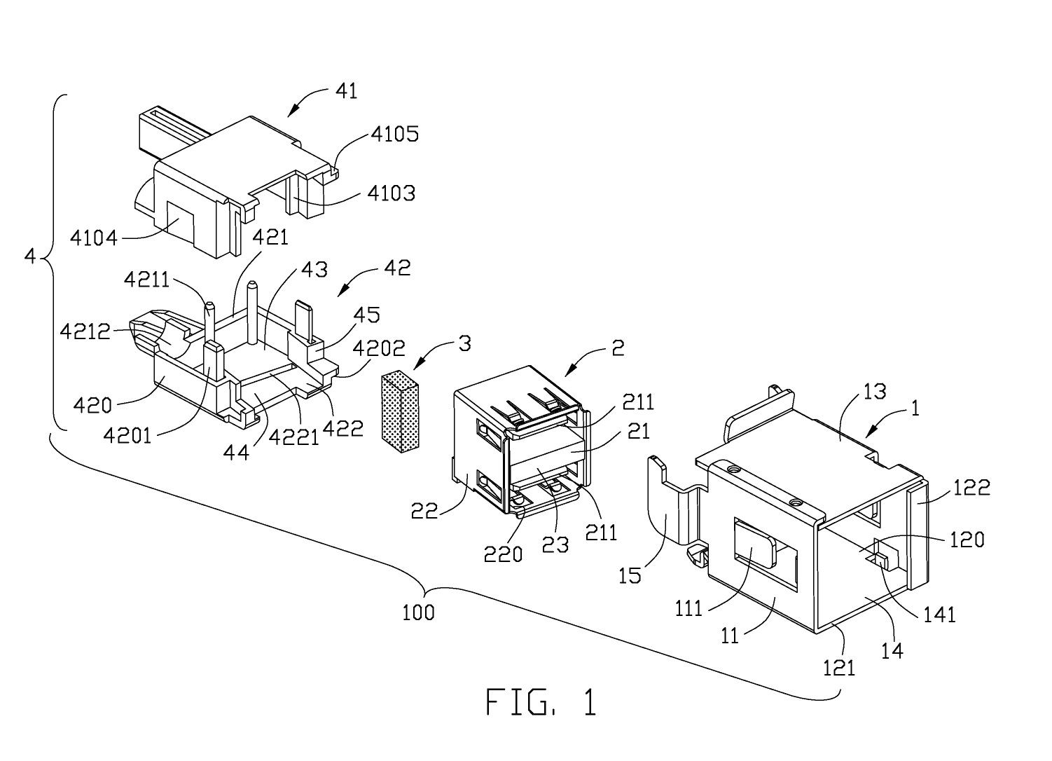

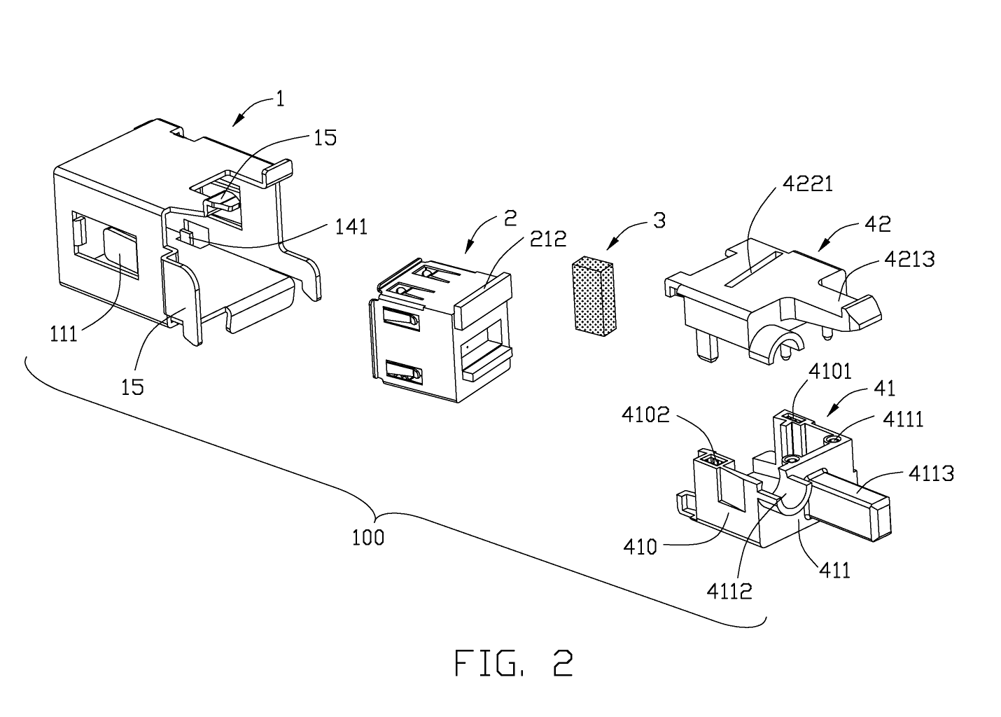

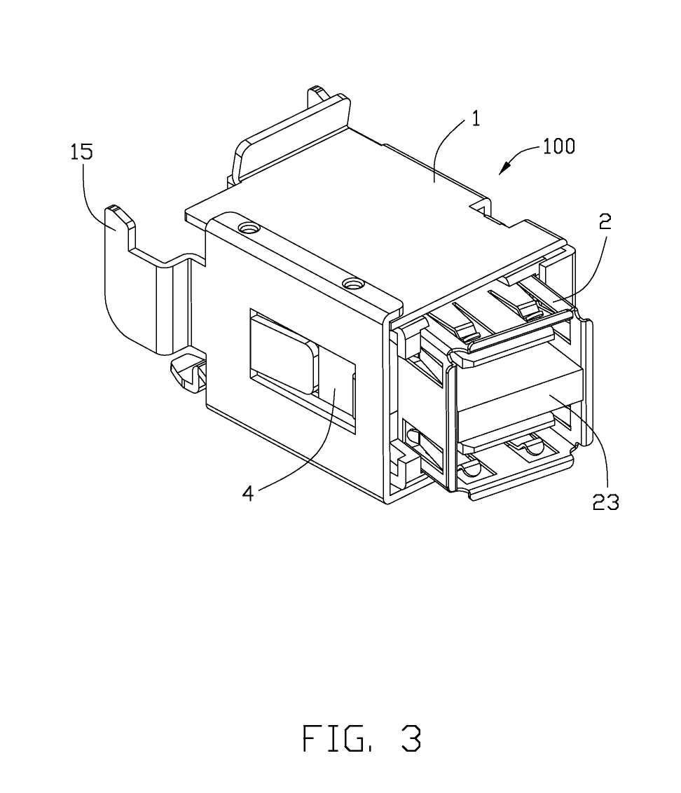

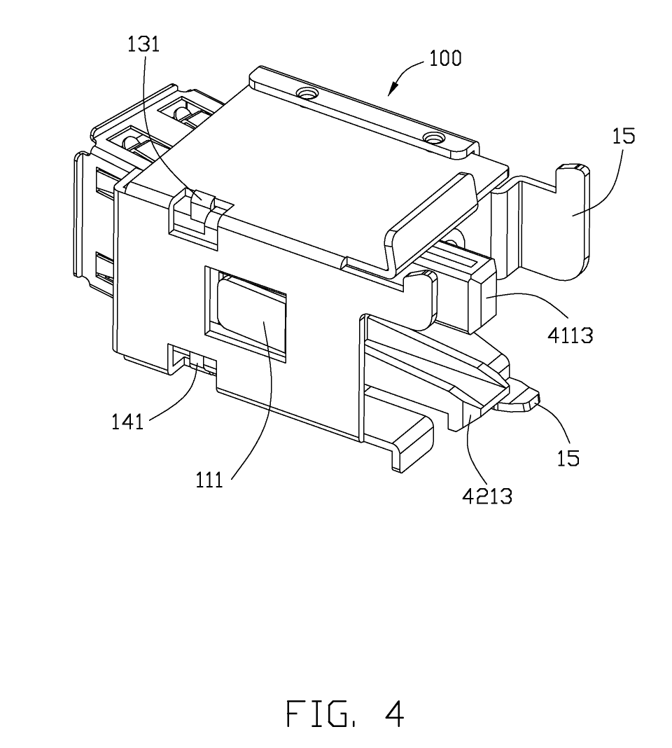

Referring to FIGS. 1-4, a connector assembly 100 in accordance with the present invention comprises a metallic shell 1, a connector 2, an electrically conductive foam 3 and an insulative cover 4.

The metallic shell 1 forms a hollow 120 to accommodate the connector 2 and the insulative cover 4 therein. The metallic shell 1 has two lateral sides 11, and each lateral sides 11 has a tab 111 extending into the hollow 120. Accordingly, a depression 4104 is defined in a lateral wall 410 of an upper cover 41 of the insulative cover 4. The tab 111 is engaged with the depression 4104 when the insulative cover 4 is assembled to the metallic shell 1. Two locking members 131, 141 are respectively formed with a top side 13 and a bottom side 14 and protrude into the hollow 120. Two positioning slots 4105, 4202 are defined in front corners of the upper cover 41 and the lower cover 42 to receive the two locking members 131, 141. A blocking member 122 is formed with the metallic shell 1 and located in front of a front opening 121 of the metallic shell 1. The blocking member 122 prevents the connector 2, the electrically conductive foam 3 and the insulative cover 4 sliding outward of the metallic shell 1. A number of retaining members 15 extend rearwardly from back edge of the metallic shell 1.

The connector 2 is a USB connector and includes an insulated housing 21 and a metal shell 22 enclosing the insulated housing 21. The insulated housing 21 has two tongue portions 211 spaced apart from each other along a vertical direction, and each tongue portion 211 supporting a number of terminals (not shown) to form a mating portion 23. Rear portions of the terminals are connected to corresponding wires (not shown) and the wires are further connected to a motherboard of the computer. A positioning rib 212 is formed at a back edge of the insulative housing 21 and further extends along a vertical direction. The metal shell 22 has a forward opening 220 to expose the mating portion 23 outward.

The lower cover 42 of the insulative cover 4 has a pair of lateral walls 420, and each lateral wall 420 forms a first positioning post 4201 projected upwardly from a top edge thereof. Two second positioning posts 4211 are arranged in the lower cover 42 and adjacent to a back wall 421 of the lower cover 42. The upper cover 41 defines two first positioning cavities 4101 to receive the first positioning post 4201. Each positioning cavity 4101 further has crushable ribs 4102 therein to increase engagement between the first positioning cavity 4101 and the first positioning post 4201. Two second receiving slots 4111 are defined proximate to a back wall 411 of the upper cover 41 to accommodate the second positioning posts 4211. The upper cover 41 and the lower cover 42 cooperate a roomage therebetween. A latching member 4213 projects rearwardly from the back wall 421 of the lower cover 42. An aligning beam 4113 protrudes rearwardly from the back wall 411 of the upper cover 41. The insulative cover 4 is securely fixed to the mounting board 5 by the latching member 4213 and the aligning beam 4113. Two cable holders 4112, 4212 is projected rearwardly from back walls 411, 421, and the two cable holders 4112, 4212 cooperate together to grip the cable therebetween. The lower cover 42 further has a locating cavity 44 which is defined in a front segment thereof. The locating cavity 44 extends along a direction offsetting a front-to-back direction. A positioning passage 4221 is defined in a bottom wall 422 of the lower cover 42 and communicates with the locating cavity 44. A flange 4103 formed on an inner side of a front segment of the lateral wall 410 of the upper cover 41.

When assembly, the connector 2 is mounted to the locating cavity 44 of the lower cover 42, and the positioning rib 212 is inserted into the positioning passage 4221, and the upper cover 41 is mounted to the lower cover 42, with a back edge of the connector 2 against the flange 4103. Therefore, the connector 2 is retained/held by the upper cover 41 and the lower cover 42 reliably. The electrically conductive foam 3 is put into a cutout 45 which is defined in a front end of the lateral wall 420 and contacts with metal shell 22. The connector 2 and the insulative cover 4 is assembled to the metallic shell 1, with the electrically conductive foam 3 contacts the metallic shell 1, therefore a grounding line is formed between the metal shell 22, the electrically conductive foam 3 and the metallic shell 1.

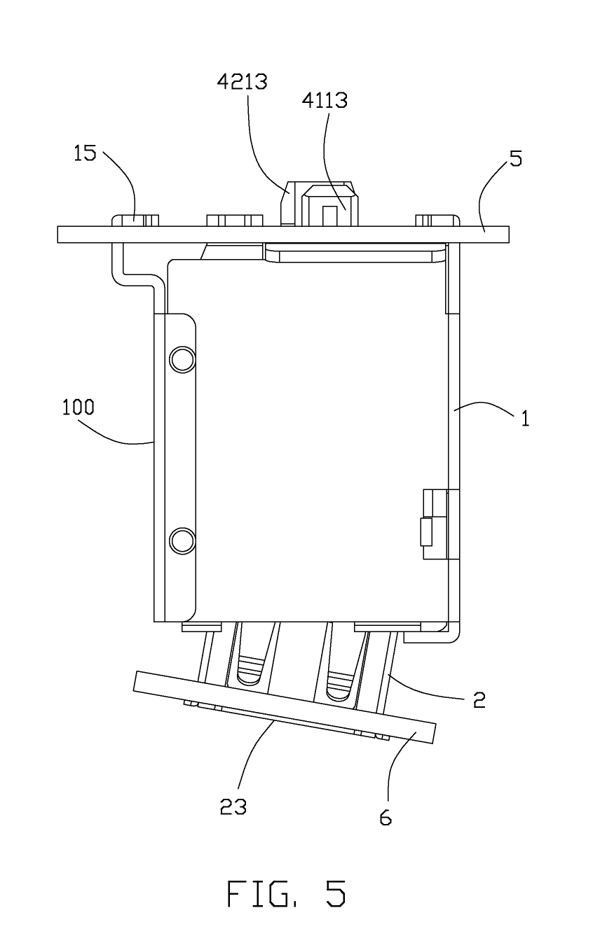

Referring to FIG. 5 in conjunction with FIGS. 1-4, showing the connector assembly 100 mounted inside a cage of a computer or other electronic device. In order to clearly illustrate a relationship between the connector 2 and the cage, only a sloped front panel 6 of the cage and a mounting board 5 inside the cage are shown, other elements of and inside the cage is omitted. The mounting board 5 is located behind the front panel 6, with the connector assembly 100 is arranged therebetwwen. The front panel 6 is disposed oblique to the mounting board 5, rather than arranged in parallel to the mounting board 5. The metallic shell 1 and the insulative cover 4 is fixed to the mounting board 5 and perpendicular to/orthogonally with the mounting board 5. The connector 2 is oblique to the mounting board 5 but perpendicular to the front panel 6, with the mating portion 23 thereof protruding into a port defined in the front panel 6. By this configuration, the connector assembly 100 can be mounted to the front panel 6, even the front panel 6 is sloped.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A connector assembly adapted for mounting to a front panel of a cage, comprising:
an insulative cover having an upper cover and a lower cover extending along a front-to-back direction, at least one locating cavity defined in a front segment of the lower cover, the locating cavity extending along a direction angled with the front-to-back direction;
a connector accommodated in the locating cavity and held by the upper cover and the lower cover; and
the connector disposed perpendicular to the front panel and the insulative cover disposed oblique to the front panel.

2. The connector assembly as recited in claim 1, wherein the connector includes an insulated housing and a metal shell enclosing the insulated housing.

3. The connector assembly as recited in claim 2, wherein the insulated housing of the connector has a positioning rib formed at a back edge thereof and inserted into a positioning passage which is defined in the locating cavity.

4. The connector assembly as recited in claim 2, wherein the upper cover has a flange formed on an inner side of a lateral wall thereof, the connector is arranged against the flange.

5. The connector assembly as recited in claim 2, further comprising a metallic shell shielding the electrical connector and the insulative cover.

6. The connector assembly as recited in claim 5, wherein an electrically conductive foam is located between the metal shell of the electrical connector and the metallic shell.

7. The connector assembly as recited in claim 6, wherein a front end of the lateral wall of the lower cover defines a cutout to receive the electrically conductive foam.

8. The connector assembly as recited in claim 7, wherein the metallic shell has a blocking member formed at a front edge thereof to prevent the electrically conductive foam from sliding outward of the metallic shell.

9. A connector assembly for mounting between a front panel of a cage and a mounting board inside of the cage, the front panel and the mounting board located in a vertical direction, but disposed nonparallel to each other, comprising:
an insulative cover fixed to the mounting board;
a connector held by the insulative cover, the connector defining a mating portion oblique to the insulative cover, the mating portion of the connector forwardly extending outward via a port defined in the front panel, and
wherein the insulative cover is perpendicular to the mounting board, and the connector is perpendicular to the front panel.

10. The connector assembly as recited in claim 9, wherein the insulative cover includes an upper cover and a lower cover combined together to retain the connector.

11. The connector assembly as recited in claim 10, wherein a latching member projects rearwardly from a back wall of the lower cover and latches with the mounting board.

12. The connector assembly as recited in claim 9, wherein the connector assembly further has a metallic shell shielding the connector and the insulative cover.

13. The connector assembly as recited in claim 12, wherein the metallic shell has a retaining member formed at a back edge thereof and latches with the mounting board.

14. The connector assembly as recited in claim 12, wherein the metallic shell is orthogonal with the mounting board and oblique to the sloped front panel.

15. An electrical connector assembly comprising:
a tubular metallic shell defining an axial direction thereof and two opposite ends along said axial direction;
a insulative cover enclosed in the shell and defining a receiving cavity extending along a front-to-back direction angled with said axial direction;
an electrical connector snugly received in the receiving cavity and defining a mating port extending beyond the front end in said front-to-back direction; and
a plurality of wires extending from said connector and out of the rear end;
wherein
the rear end defines structures to fasten to a mounting board which is perpendicular to said axial direction.

16. The electrical connector assembly as claimed in claim 15, wherein said shell is essentially of a rectangular configuration.

17. The electrical connector assembly as claimed in claim 15, wherein said connector is essentially of a rectangular configuration.

18. The electrical connector assembly as claimed in claim 15, wherein the connector includes a shield electrically connected to the shell.

19. The electrical connector assembly as claimed in claim 18, wherein electrical connection between the shell and the shield is performed via an elastomeric conductive form.

20. The electrical connector assembly as claimed in claim 15, wherein said cover includes upper and lower halves respectively equipped with a latch member and an alignment member.
